(19) United States
(12) Patent Application Publication
(10) Pub. No.: US 2011/0011932 A1
(43) Pub. Date: Jan. 20, 2011

(54) COMMODITY INFORMATION READING AND DISPLAYING APPARATUS

(75) Inventors: Takashi Tsuyuki, Shizuoka (JP); Masato Suzuki, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/834,181

(22) Filed: Jul. 12, 2010

(30) Foreign Application Priority Data
Jul. 16, 2009 (JP) 2009-167826

(51) Int. Cl. G07G 1/01

(52) U.S. Cl. 235/383

(57) ABSTRACT

According to one embodiment, a commodity information reading and displaying apparatus includes a housing, a reading window, a display device, and a light blocking sheet. The reading window is provided on one surface of the housing and configured to read predetermined information from a commodity held over the reading window. The display device is provided on a surface opposite to the surface of the housing, on which the reading window is provided, and configured to display information concerning the commodity held over the reading window. The light blocking sheet is attached to the display device and configured to limit an angle of field of a display surface of the display device to a direction deviating from the front of the display surface.

### CROSS-REFERENCE TO RELATED APPLICATIONS

This application is based upon and claims the benefit of priority from Japanese Patent Application No. 2009-167826, filed Jul. 16, 2009; the entire contents of which are incorporated herein by reference.

### FIELD

Embodiments described herein relate generally to a commodity information reading and displaying apparatus provided in a store that sells actual commodities at retail and configured to optically read, from the actual commodities sold at retail, information for specifying the commodities and display, on the basis of the read information, names, sales prices, and the like of the commodities to customers.

### BACKGROUND

In a store that sells a large volume of commodities to general consumers at retail such as a supermarket, commodities themselves to be sold are displayed. A customer puts commodities that the customer purchases in a basket, a cart, or the like and moves to a register counter.

In general, the register counter includes, near the center thereof, a barcode scanner that is an example of a commodity information reading and displaying apparatus. A checkout information registering apparatus such as a POS (Point Of Sales) terminal configured to perform processing concerning payment of a price is set near an exit of the register counter. A reading window over which a store clerk holds a barcode is provided on the side of a standing position of the store clerk. A display device for a customer is provided on the side of a standing position of the customer.

The store clerk holds commodities, which are carried by the customer to the register counter, over the reading window and causes the barcode scanner to read barcodes attached to the commodities. Information such as commodity names, commodity prices, and the like specified on the basis of the barcodes read from the commodities is displayed on the display device.

The customer stays near an entrance of the register counter and watches the store clear holding the commodities over the reading window. Alternatively, the customer moves to the front of the display device and checks whether the displayed information is right or wrong. Some customer stays in a position where the customer can simultaneously see a commodity placed in front of the reading window and a display screen of the display device (the entrance side or the exit side of the resister counter) and waits for the work of the store clerk to be completed while checking consistency of information displayed on the display device and actual commodities held over the reading window.

When the store clerk is performing the work for holding the commodities over the reading window, if the customer moves to the exit side of the register counter, a line of customers waiting for turn also proceeds to the exit side and congestion is eased. The customer moving to the exit side of the register counter approaches the checkout information registering apparatus. Therefore, time required for checkout processing can be reduced.

According to the circumstances explained above, there is a demand for a commodity information reading and displaying apparatus configured to more surely urge movement of a customer, who is about to check consistency of commodities held over the reading window and display content of the display device, and cause a checkout job in the register counter to smoothly proceed.

### BRIEF DESCRIPTION OF THE DRAWINGS

FIG. 1 is an external perspective view of a commodity information reading and displaying apparatus in an embodiment;

FIG. 2 is a disassembled perspective view of a display device in the embodiment;

FIG. 3 is a schematic diagram for explaining checkout in the embodiment; and

FIG. 4 is a schematic diagram for explaining the checkout in the embodiment.

### DETAILED DESCRIPTION

In general, according to one embodiment, a commodity information reading and displaying apparatus includes a housing, a reading window, a display device, and a light blocking sheet. The reading window is provided on one surface of the housing and configured to read predetermined information from a commodity held over the reading window. The display device is provided on a surface opposite to the surface of the housing, on which the reading window is provided, and configured to display information concerning the commodity held over the reading window. The light blocking sheet is attached to the display device and configured to limit an angle of field of a display surface of the display device to a direction deviating from the front of the display surface.

An embodiment of the commodity information reading and displaying apparatus is explained below with reference to the accompanying drawings. In this embodiment, a commodity information reading and displaying apparatus including a barcode scanner configured to optically read commodity specifying information from a barcode attached to a commodity and display a commodity name and a commodity price corresponding to the commodity specifying information on a display device is explained as an example.

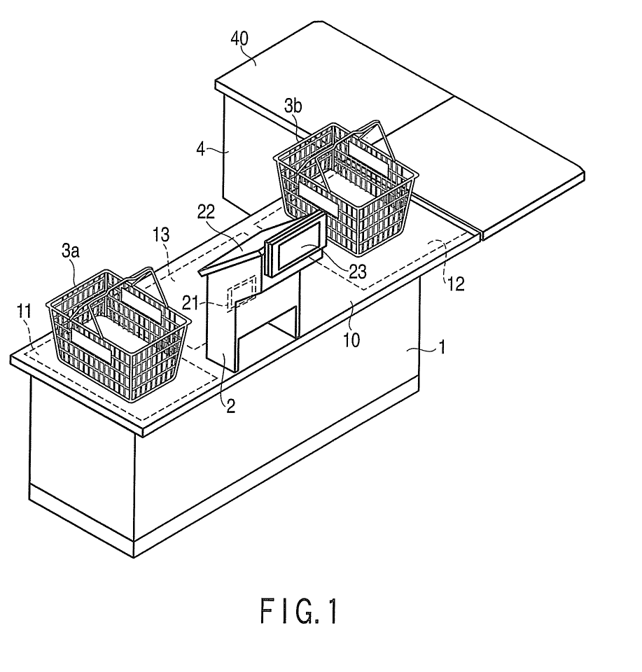

FIG. 1 is an external perspective view of the commodity information reading and displaying apparatus according to this embodiment. The apparatus is set in a checkout place in a store that sells actual commodities at retail such as a supermarket. The apparatus includes a checkout counter and a commodity-information reading unit 2. The checkout counter includes an elongated register counter 1 in which a barcode scanner is provided and a placing table 4 annexed to the register counter 1. The housing of the commodity-information reading unit 2 is vertically provided near a position substantially in the center with respect to a longitudinal direction of the register counter 1.

The register counter 1 is arranged along a checkout lane, through which a customer passes during checkout, to separate a standing position of a customer who finishes payment of a price of commodities and a standing position of a store clerk who engages in a checkout job (hereinafter referred to as cashier). A flat commodity receiving surface 10 for placing a basket 3 thereon is provided on the upper surface of the register counter 1. A flat placing surface 40 for placing a POS terminal thereon is provided in an upper part of the placing table 4.

In the commodity-information reading unit 2, a scanner configured to optically read a barcode as a symbol code attached to a commodity is incorporated in the housing. A reading window 21 for the scanner is provided on a surface of the housing on the side of the standing position of the cashier. A display device 23, a display surface of which is directed to a customer side, is provided on a surface opposite to the surface of the housing on which the reading window 21 is provided (a surface on the side of the standing position of the customer). An operation unit 22 including a keyboard inclined to the cashier side is provided on the upper surface of the commodity-information reading unit 2. In the operation unit 22, various operation keys such as numeric keys for inputting a numerical value and a declaration key for price-cut and discount for a commodity are disposed. Input of commodity specifying information concerning a commodity not attached with a barcode and input of a price-cut amount and a discount rate for a commodity are performed by the operation of these operation keys.

The commodity-information reading unit 2 is connected to a not-shown POS terminal placed on the placing table 4 via a communication line that enables mutual communication. Commodity specifying information read by the scanner and information input via the operation unit 22 are transmitted to the POS terminal via the communication line.

Latitudinal direction width of the register counter 1 has a width dimension larger than longitudinal direction width of the basket 3. The commodity receiving surface 10 on the left side viewed from a direction opposed to the display surface of the display device 23 is an area 11 for placing a basket 3a containing commodities that a customer is about to purchase. In other words, commodities, commodity specifying information of which is not input, are placed on the area 11. On the other hand, a position opposed to the area 11 on the commodity receiving surface 10 across the commodity-information reading unit 2 is an area 12 for placing a basket 3b containing commodities, commodity specifying information of which is just input. Exchange of money with a customer C who moves forward on the checkout lane is performed near a position opposed to the placing table 4, on which the POS terminal is placed, across the register counter 1, i.e., the area 12.

An area between the area 11 and the area 12 is an area 13 for moving the basket 3 from the area 11 to the area 12. A dimension of the area 13 is set to a dimension larger than latitudinal direction width of the basket 3. The commodity-information reading unit 2 is interposed and vertically provided between the area 11 and the area 12 and the dimension of the area 13 is set as explained above in order to smoothly advance a checkout job explained later.

The configuration of the display device 23 is explained below.

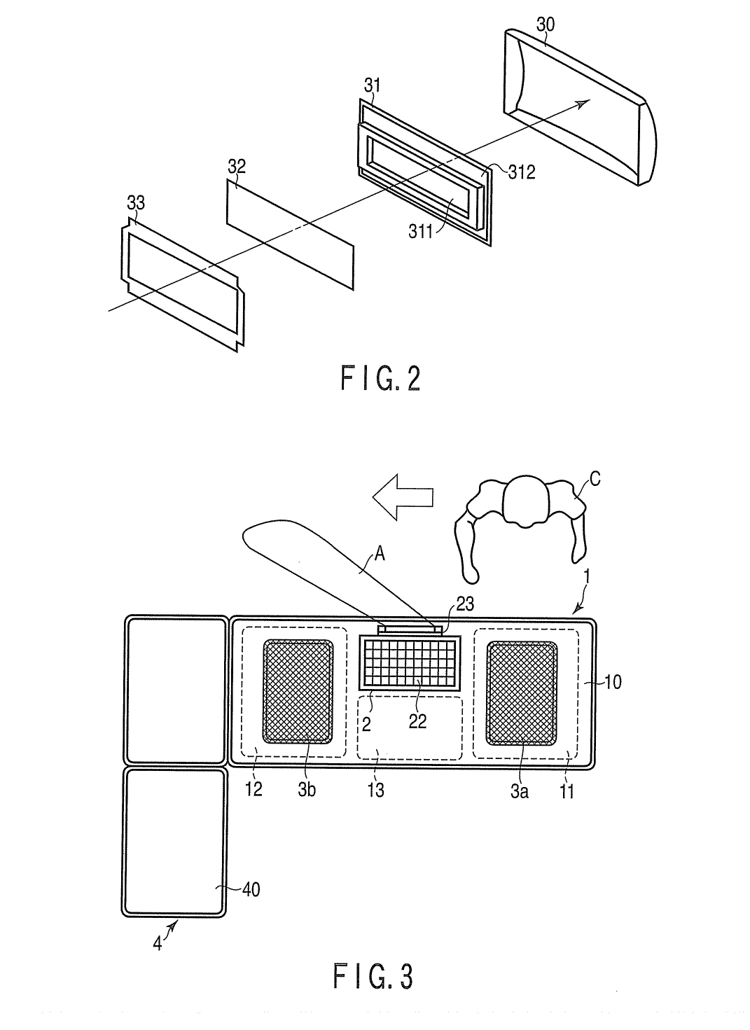

FIG. 2 is a disassembled perspective view of the display device 23. The display device 23 includes a rear cover 30 fixed to the housing of the commodity-information reading unit 2, a rectangular display member 31, a peripheral section 312 of which is provided around a display surface 311, a light blocking sheet 32 formed in a rectangular flat shape and configured to cover the display surface 311, and a frame-like front bezel 33 including an opening having size corresponding to the display surface 311.

When the display member 31 is fit in the rear cover 30 and the front bezel 33 is attached to the rear cover 30 to be placed over the display member 31, the rear cover 30 and the front bezel 33 sandwich the peripheral section 312 of the display member 31 to fix the display member 31. When the display member 31 is fixed to the rear cover 30 in this way, the display surface 311 is exposed from the opening of the front bezel 33. In this state, the light blocking sheet 32 is stuck to the display surface 311 by using a substantially transparent adhesive.

As a method of fixing the rear cover 30 to the housing of the commodity-information reading unit 2, various methods can be adopted. For example, plural through holes are provided in the rear cover 30, female screws corresponding to the through holes are provided in predetermined positions of the housing of the commodity-information reading unit 2, and male screws corresponding to the female screws are inserted into the through holes of the rear cover 30 and screwed into the females screws to fix the rear cover 30 to the housing.

The display member 31 includes a VFD (vacuum fluorescent display) that generally has an angle of field in a wider range than that of the display surface including an LCD (Liquid Crystal Display) or an LED (Light Emitting Diode) and is manufactured at low cost. The display member 31 is connected to a control circuit for the commodity-information reading unit 2 via a flexible printed board. The display member 31 displays information such as numerical values and characters on the display surface 311 on the basis of a display signal sent from the control circuit.

As the light blocking sheet 32, for example, a sheet obtained by coating both sides of a louver layer with a transparent protective layer is used. The louver layer has a configuration in which plural very small louvers are arranged in parallel to one another at fixed intervals. Transmittances from respective visual recognition directions of the louver layer depend on the tilt, an arrangement interval, and the like of the very small louvers. Therefore, by selecting a type of the louver layer, it is possible to set an angle of field of the display device 23 to a desired angle. In the explanation of this embodiment, as an example, a light blocking sheet for limiting the angle of field of the display device 23 to a position on the exit side of the checkout lane where exchange of a price with a customer is expected (near the area 12) is adopted.

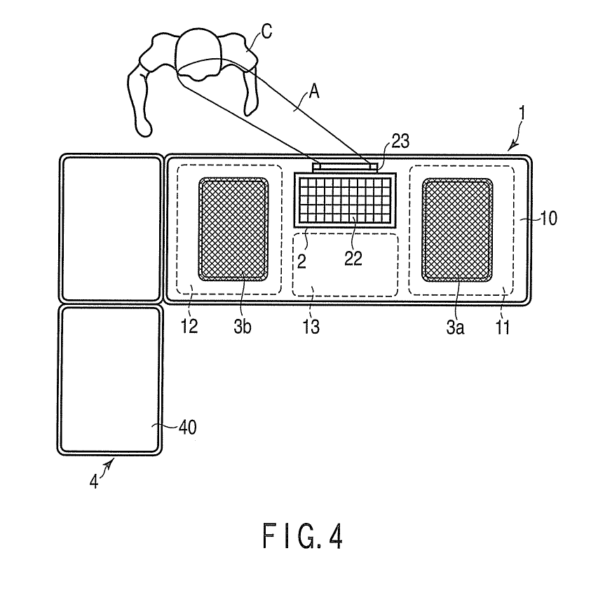

A flow of a checkout job performed by using the commodity information reading and displaying apparatus having the configuration explained above is explained with reference to FIGS. 3 and 4. FIGS. 3 and 4 are schematic diagrams for explaining a checkout job performed in a register in which the commodity information reading and displaying apparatus is set.

FIGS. 3 and 4 are diagrams of the checkout counter shown in FIG. 1 viewed from above.

First, the customer C places the basket 3a containing commodities on the area 11 of the register counter 1. At this point, the cashier operates the operation unit 22 to declare the start of reading of commodity specifying information and transfers, while sequentially taking out the commodities from the basket 3a and holding barcodes attached to the commodities over the reading window 21, the commodities, reading of barcodes of which is completed, to the empty basket 3b placed on the area 12. When the barcodes attached to the commodities are held over the reading window 21, commodity specifying information represented by the barcodes is optically read by the scanner. Concerning commodities to which barcodes are not attached, the cashier operates the operation unit 22 to input commodity specifying information as explained above.

The commodity information read by the scanner and the commodity information input from the operation unit 22 are transmitted to the POS terminal via the communication line. The POS terminal specifies information such as commodity names and commodity prices from a PLU (Price Look Up) file on the basis of the commodity information transmitted from the commodity-information reading unit 2. The information specified from the PLU file is registered in a memory area for commodity information registration formed in a storage unit such as a RAM (Random Access Memory). The information that should be displayed on the display device 23 such as the commodity names and the commodity prices is returned to the commodity-information reading unit 2 via the communication line. A control unit of the commodity-information reading unit 2 receives the return of the information and outputs a display signal corresponding to the returned information to the display member 31. The display member 31 receives the input of the display signal and displays the information based on the display signal, i.e., the commodity names and the commodity prices on the display surface 311.

While the cashier performs the input work for the commodity information, the customer C waits for the commodity information of all the commodities to be input while checking consistency of the actual commodities held over the reading window 21 and the information displayed on the display device 23. As explained above, the display device 23 is provided on the surface opposite to the surface of the housing of the commodity-information reading unit 2 on which the reading window 21 is provided. Therefore, in checking the consistency, a line of sight of the customer C looking at the commodities held over the reading window 21 is not blocked by the display device 23. It is unnecessary to provide a display device of the commodity information reading and display apparatus on the exit side of the checkout lane. Therefore, there is no obstacle to basket handling for placing a basket on the exit side of the checkout lane and moving the basket.

If the light blocking sheet 32 is not attached to the display device 23, the angle of field of the display device 23 is wide to the left and right. Therefore, it is possible to visually recognize displayed content even near the front of the area 11 (e.g., the standing position of the customer C shown in FIG. 3).

If the light blocking sheet 32 is attached to the display device 23, as indicated by the area A shown in FIGS. 3 and 4, the angle of field of the display device 23 is limited to the exit side of the checkout lane. Therefore, the customer C naturally moves to the exit side of the checkout lane in order to visually recognize display content of the display device 23 after the cashier starts input of commodity information.

When the reading of the commodity specifying information is completed for all the commodities stored in the basket 3 placed on the area 11, the cashier operates the keyboard of the POS terminal to declare closing of the transaction. At this point, a price of the transaction is calculated on the basis of the commodity information registered in the memory area for commodity information registration of the POS terminal. The customer C pays the price by cash, a credit card, electronic money, or the like, receives a receipt issued by the POS terminal and change, carries the basket 3b placed on the area 12 to a sucker table set on the inside or the outside of the store, replaces the commodities in a register bag or an ecological bag, and leaves the store.

After the customer C carries the basket 3b away from the register counter 1, the cashier slides the emptied basket 3a from the area 11 to the area 13 through the area 12. The cashier slides the basket 3 placed on the area 11 by the next customer to pull the basket 3 over to the commodity-information reading unit 2 side and starts a checkout job for the customer.

In this way, in the register in which the commodity information reading and displaying apparatus in this embodiment is set, the angle of field of the display device 23 is set on the exit side of the checkout lane. Consequently, a customer being checked out is naturally guided to the exit side of the checkout lane. The next customer waiting for checkout can easily move forward into the checkout lane. Therefore, it is possible to prevent customers waiting for checkout from being pushed out to a passage in the store. Further, if the customer C is guided to the exit side, after reading of commodity specifying information is completed and a transaction is closed, the customer C can immediately perform, for example, exchange of a price with the cashier. Therefore, checkout smoothly proceeds.

The display device 23 is provided in the commodity-information reading unit 2 without using a mechanical operation member such as a swivel mechanism. Therefore, it is unnecessary to feel anxiety about a failure of a mechanical operation section. Further, as a method of attaching the display device 23, an extremely simple method with a small number of components such as the fixing method explained in the embodiment can be adopted. Therefore, it is possible to realize a reduction in manufacturing cost for the commodity information reading and displaying apparatus.

The simple structure of attaching the light blocking sheet 32 to the display surface 311 of the display member 31 exposed from the front bezel 33 is adopted. Therefore, it is possible to manufacture the commodity information reading and displaying apparatus according to the present embodiment directly using a manufacturing facility for the commodity information reading and displaying apparatus in the past. Further, the light blocking sheet 32 can be easily replaced with a light blocking sheet having a different control range of an angle of field. Therefore, it is possible to appropriately adjust a guiding position for a customer to a position suitable for operation of the store.

The commodity information reading and displaying apparatus explained in the embodiment can be embodied with the configuration thereof modified as appropriate.

For example, in the embodiment, the commodity-information reading unit 2 reads a barcode of a commodity held over the reading window 21 and inputs commodity specifying information. However, if a symbol mark other than the barcode such as a two-dimensional code is attached to the commodity, the commodity-information reading unit 2 may read the symbol mark and input commodity information. The reading window 21 does not have to be vertically provided. The reading window 21 may be provided to be tilted such that the front surface thereof faces further downward on the cashier side than when the front surface of the reading window 21 is vertically provided or may be provided to be laid with the front surface facing upward on the cashier side. Besides, it is also possible that a hand scanner is connected to the commodity-information reading unit 2 and the cashier reads the symbol mark attached to the commodity using the hand scanner and input commodity specifying information.

A method of inputting commodity specifying information is not limited to the reading of the symbol code by the scanner and other methods may be adopted. For example, an imaging device such as a CCD camera configured to pickup an image of a commodity held over the reading window 21 and a device for detecting attributes such as a shape and a color of a commodity from the image picked up by the imaging device and specifying a type of the commodity on the basis of detected information are provided in the commodity-information reading unit 2. Information such as a commodity name and a commodity price corresponding to the specified type of the commodity is displayed on the display device 23. When such a configuration is adopted, it is possible to obtain an effect same as that in the embodiment.

A method of attaching the light blocking sheet 32 to the display member 31 is not limited to the method of attaching the light blocking sheet 32 using the adhesive. Besides, various methods can be adopted such as a method of attaching the light blocking sheet 32 by sandwiching, together with the display member 31, the light blocking sheet 32 between the rear cover 30 and the front bezel 33.

A display form of the display member 31 is not limited to the vacuum fluorescent display. Besides, when an LED or an LCD is adopted, an effect same as that in the embodiment can be obtained. Further, information displayed on the display device 23 is not limited to a commodity name and a commodity price. Commercial information and the like of the store may be displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity information reading and displaying apparatus comprising:
a housing;
a reading window provided on one surface of the housing and configured to read predetermined information from a commodity held over the reading window;
a display device provided on a surface opposite to the surface of the housing, on which the reading window is provided, and configured to display information concerning the commodity held over the reading window; and
a light blocking sheet attached to the display device and configured to limit an angle of field of a display surface of the display device to a direction deviating from the front of the display surface.

2. The apparatus according to claim 1, wherein
the apparatus is provided in a position along a checkout lane through which a customer passes during checkout of a commodity, and
the light blocking sheet limits the angle of field of the display surface of the display device to an exit side of the checkout lane.

3. The apparatus according to claim 1, wherein the display device includes:
a rear cover fixed to the housing;
a display member having a display surface on which the information concerning the commodity is displayed; and
a front bezel configured to expose the display surface and fix the display member to the rear cover, and
the light blocking sheet is attached to cover the display surface of the display member exposed from the front bezel.

4. The apparatus according to claim 3, wherein the display member is a vacuum fluorescent display.

5. The apparatus according to claim 1, wherein the information displayed by the display device includes at least one of a commodity name and a unit price of the commodity held over the reading window.

6. A commodity information reading and displaying apparatus comprising:
a housing provided on a register counter configured to separate, along a checkout lane through which a customer passes during checkout of a commodity, standing positions of the customer and a store clerk engaging in a checkout job;
a reading window provided on a surface of the housing on the store clerk standing position side and configured to read predetermined information from a commodity held over the reading window;
a display device provided on a surface of the housing on the customer standing position side and configured to display information concerning the commodity held over the reading window; and
a light blocking sheet attached to the display device and configured to limit an angle of field of a display surface of the display device to a direction deviating from the front of the display surface.

7. The apparatus according to claim 6, wherein the light blocking sheet limits the angle of field of the display surface of the display device to an exit side of the checkout lane.

8. The apparatus according to claim 6, wherein
the display device includes:
a rear cover fixed to the housing;
a display member having a display surface on which the information concerning the commodity is displayed; and
a front bezel configured to expose the display surface and fix the display member to the rear cover, and
the light blocking sheet is attached to cover the display surface of the display member exposed from the front bezel.

9. The apparatus according to claim 6, wherein the information displayed by the display device includes at least one of a commodity name and a unit price of the commodity held over the reading window.

10. A commodity information reading and displaying apparatus comprising:
a register counter provided along a checkout lane through which a customer passes during checkout of a commodity and configured to separate standing positions of the customer and a store clerk engaging in a checkout job;
a housing provided on the register counter;
a reading window provided on a surface of the housing on the store clerk standing position side and configured to read predetermined information from a commodity held over the reading window;
a display device provided on a surface of the housing on the customer standing position side and configured to display information concerning the commodity held over the reading window; and
a light blocking sheet attached to the display device and configured to limit an angle of field of a display surface of the display device to a direction deviating from the front of the display surface.
